(19) United States
(12) Patent Application Publication
(10) Pub. No.: US 2008/0001868 A1
(43) Pub. Date: Jan. 3, 2008

(54) Method of fabricating resistive touch panel

(75) Inventors: Chun-Hao Wang, Changhua County (TW); Chien-Chung Kuo, Taichung County (TW)

Correspondence Address: BACON & THOMAS, PLLC, 625 SLATERS LANE, FOURTH FLOOR, ALEXANDRIA, VA, 22314, US

(73) Assignee: Wintek Corporation, Taichung (TW)

(21) Appl. No.: 11/453,812

(22) Filed: Jun. 16, 2006

(51) Int. Cl. G09G 3/36

(52) U.S. Cl. 345/87

(57) ABSTRACT

A method of fabricating a resistive touch panel, which fixes the problems of the conventional method needing a plurality of screen printing processes, has a combined process of making the barrier and the spacers. The method of the present invention has less screen printing process to lower the cost and increase the production capacity.

### BACKGROUND OF THE INVENTION

1. Field of the Invention

The present invention relates generally to a touch panel, and more particular to a simplified method of fabricating the resistive touch panel.

2. Description of the Related Art

FIG. 1 shows a common resistive touch panel 1, which has, from bottom to top, a bottom conductive substrate 2, a plurality of insulating spacers 3, a linear electrode 4, a first barrier layer 5, a conductive wire layer 6, a second barrier layer 7 and a top conductive substrate 8.

The bottom conductive layer 2 has a conductive film 2a, on which the spacers 3 are printed by screen printing. The purpose spacers 3 is to keep a suitable distance between the conductive films 2a and 8a of the bottom and top conductive substrates 2 and 8 after the touch panel 1 has been assembled that prevent the conductive films 2a and 8a from short when the touch panel 1 has not been pressed.

After making the spacers 3, the linear electrode 4 is made around the spacers 3 by screen printing, and then the first barrier layer 5 is made by screen printing also. The first barrier layer 5 covers the linear electrode 4 and has four through holes 5a and a hollow portion 5b. And then, the conductive wire layer 6 is made on the first barrier layer 5. As shown in FIG. 1, the conductive wire layer 6 consists of five independent wires, so called five-wire resistive touch panel, in which four wire 6a, 6b, 6c, and 6d are electrically connected to the linear electrode 4 through one through hole 5a, and the fifth wire 6e is are electrically connected to the conductive film 8a of the top conductive substrate 8 through a through hole 7a of the second barrier layer 7. The second barrier 7 has a hollow portion 7b also. The spacers 3 are received in a space within the hollow portions 5b and 7b of the first and second barrier layers 5 and 7.

### SUMMARY OF THE INVENTION

The primary objective of the present invention is to provide a duplicator with a reliable, faster and efficient data duplication function.

According to the objective of the present invention, a method of fabricating a resistive touch panel comprises the steps of: Providing a first conductive substrate, on which a first patterned electrode is provided to define a region on the first conductive substrate. Forming a patterned first insulating layer on the first conductive substrate, wherein the first insulating layer has a barrier covering the first patterned electrode, a plurality of spacers received in the region and a plurality of through holes through the barrier. Providing a second panel and electrically connecting the second panel to the first panel.

### BRIEF DESCRIPTION OF THE DRAWINGS

FIG. 1 is an exploded view of the conventional five-wire resistive touch panel;

FIG. 2 is an exploded view of the five-wire resistive touch panel of a preferred embodiment of the present invention;

FIG. 3 is a sectional view in combination of FIG. 2;

FIG. 4 is a flow chart of the first method of fabricating the five-wire resistive touch panel of the preferred embodiment of the present invention;

FIG. 5 is a flow chart of the second method of fabricating the five-wire resistive touch panel of the preferred embodiment of the present invention;

FIG. 7 and FIG. 8 are sectional views of the first barrier layer made by yellow light process;

FIG. 9 is similar to FIG. 3, showing a four-wire resistive touch panel; and

FIG. 10 is a flow chart of the first method of fabricating a four-wire resistive touch panel.

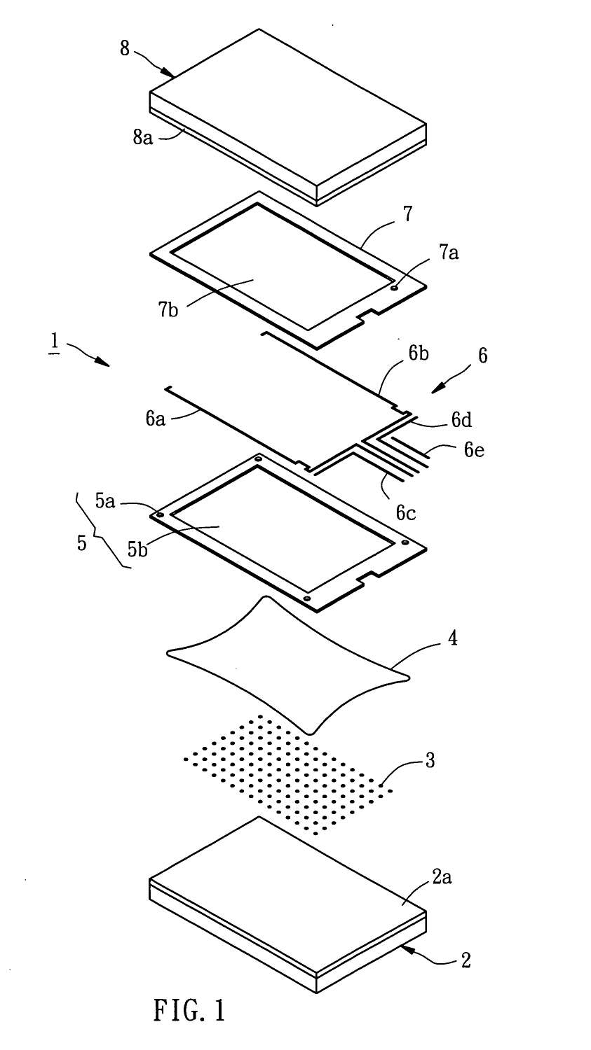

### DETAILED DESCRIPTION OF THE INVENTION

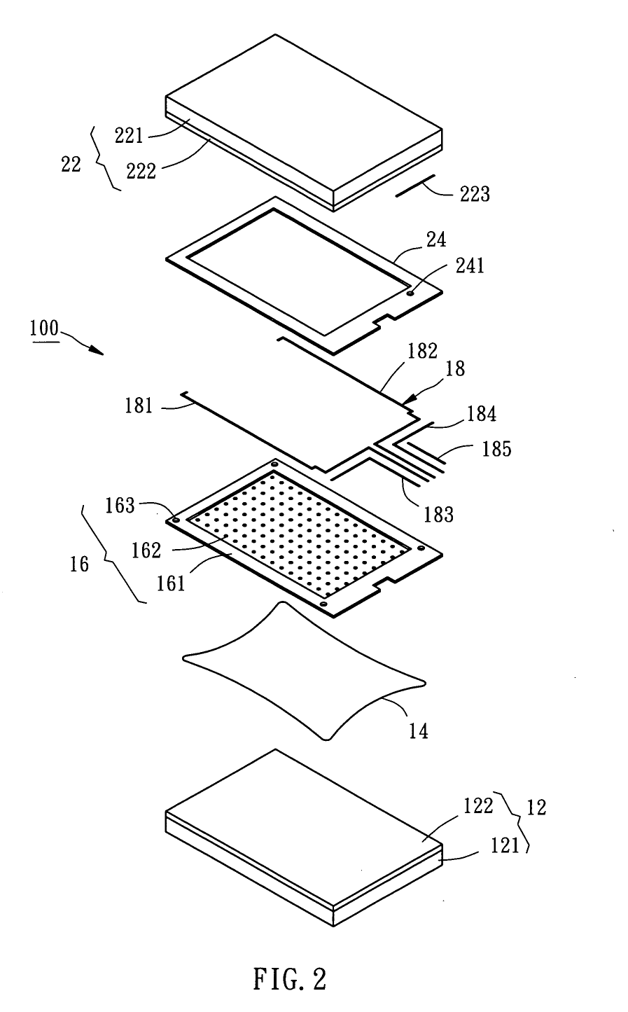

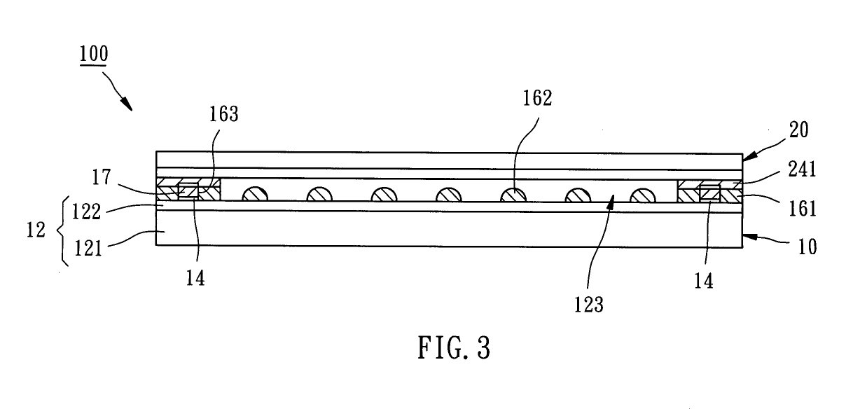

As shown in FIG. 2 and FIG. 3, a five-wire resistive touch panel 100 made by a method of the preferred embodiment of the present invention includes a first panel 10 and a second panel 20. The first panel 10 includes a first conductive substrate 12, a patterned electrode 14, a first insulating layer 16 and a second patterned electrode 18. The second panel 20 includes a second conductive substrate 22 and a second insulating layer 24.

The anterior process of making the first panel 10 and the posterior process of making the second panel 20 are described hereunder:

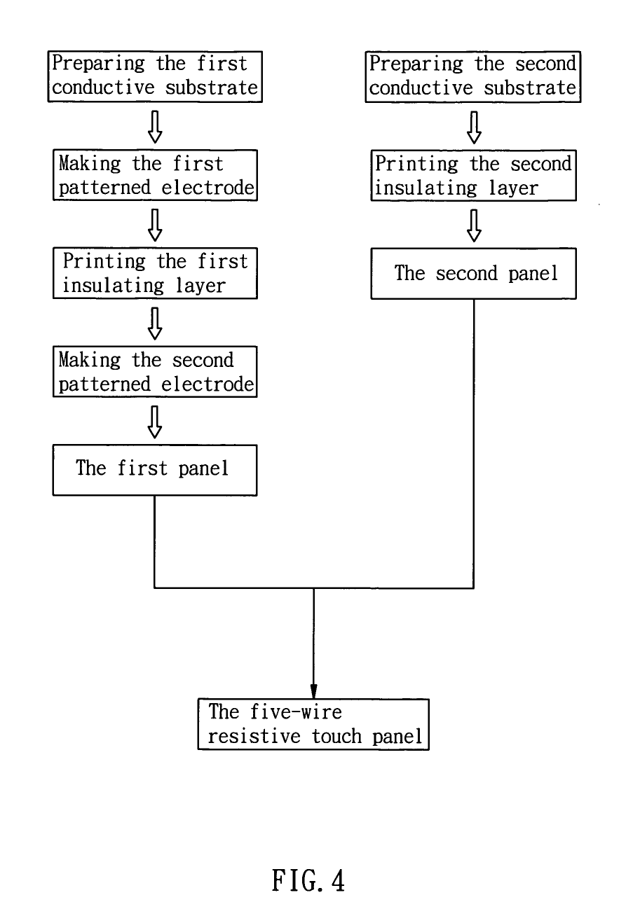

As shown in FIG. 4, the anterior process includes:

Preparing the first conductive substrate 12, which consists of a plate 121 and an ITO conductive film 122.

Printing metal wires on IOT conductive film 122 by screen printing to form the first patterned electrode 14, as shown in FIG. 2. The first patterned electrode 14 is a closed loop to surround a region 123 on the ITO conductive film 122.

Performing another screen printing process to print an insulating material on the first conductive substrate 12 to form the patterned first insulating layer 16 after the insulating material is solidified. The patterned first insulating layer 16 has a barrier 161, a plurality of spacers 162 and four through holes 163, wherein the barrier 161 is a rectangular frame covering the first patterned electrode 14, and the spacers are dots distributing in the region 123, and the four through holes 163 are located at four corners of the barrier 161 and through the barrier 161.

Providing four pads 17 made of silver in the through holes 163 to electrically connect the first patterned electrode 14.

Performing the screen printing process again to print five metal wires 181˜185 on the barrier 161, which the metal wires 181˜185 form the second patterned electrode 18, wherein the first to fourth wires 181˜184 are electrically conducted with the first patterned electrode 14 through the pads 17.

Above steps are the anterior process of making the first panel 10. The posterior process is hereunder:

Preparing the second conductive substrate 22, which consists of a plate 221 and an ITO conductive film 222. An electrode wire 223 is provided on the ITO conductive film 222.

Performing the screen printing process to print an insulating material on the second conductive substrate 22 to form the patterned second insulating layer 24. The aspect of the second insulating layer 24 is similar to that of the first insulating layer 16, except that the second insulating layer 24 only has a through hole 241, in which silver is filled to electrically conduct the fifth wire 185 and the electrode wire 223.

After the first panel 10 and second panel 20 have been made by above steps, the following step is coupling the first and second panels 10 and 20 to have the second insulating layer 24 covering the wires 181˜185. The wire 185 is electrically connected to the ITO conductive film 222 of the second conductive substrate 22 through the through hole 241 of the second insulating layer 24.

FIG. 2 and FIG. 3 show the touch panel made by above steps. It is noted that the main character of the present invention is providing one screen printing process to fabricate both of the barrier 161 and the spacers 162 at the same time. In view of fabrication, the present invention simplifies the process that benefits in lower cost of fabrication, decrease of defective ratio, shorter time of the process and increase of production capacity etc.

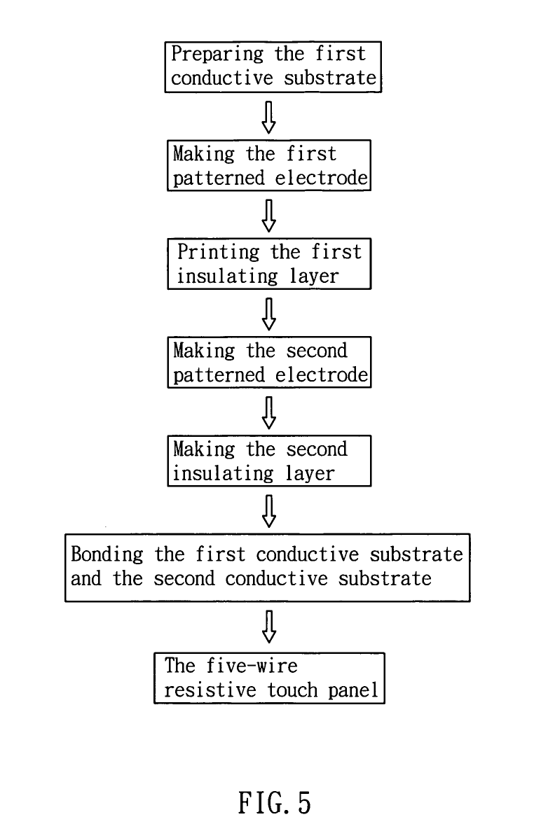

In above process, the second conductive substrate 22 is made with the second insulating layer 24 prior to couple with the first panel 10. It is noted that the method of the present invention is not limited in the coupling of the second conductive substrate 22 with the second insulating layer 24 first. In other words, the second insulating layer may be made next to the second patterned electrode 18, and then the second conductive substrate 22 is coupled with the first conductive substrate 12, as shown in FIG. 5. In addition, in the posterior process, it may further include a step of making the second patterned electrode, and there should be no second patterned electrode made in the anterior process, as shown in FIG. 6.

The method of making the fist insulating layer, except the screen printing process, further includes yellow light process.

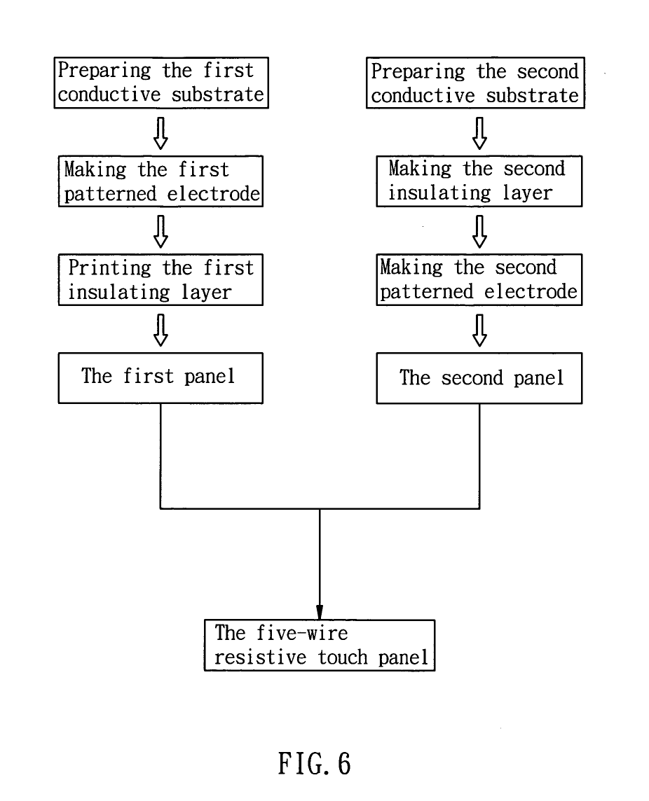

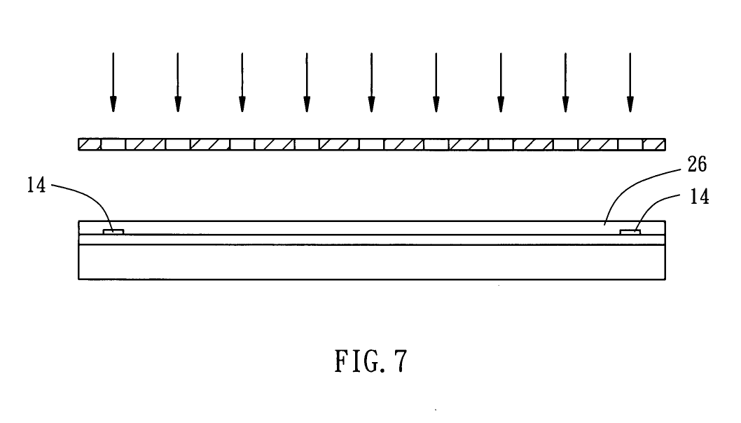

As shown in FIG. 7, after the step of making the first patterned electrode 14, coating a sensitive material on the ITO conductive film 1221 of the first conductive substrate 12. The sensitive material may be sensitive acrylic resin or sensitive polymer. And then, performing the processes of exposure and development, as shown in FIG. 8, the residual patterned photoresist layer is the first insulating layer 16′ with the barrier 161′, the spacers 162′ and the through hole 163′. This is another process of making the first insulating layer, and the following steps are as same as the above steps, and they will not be described again.

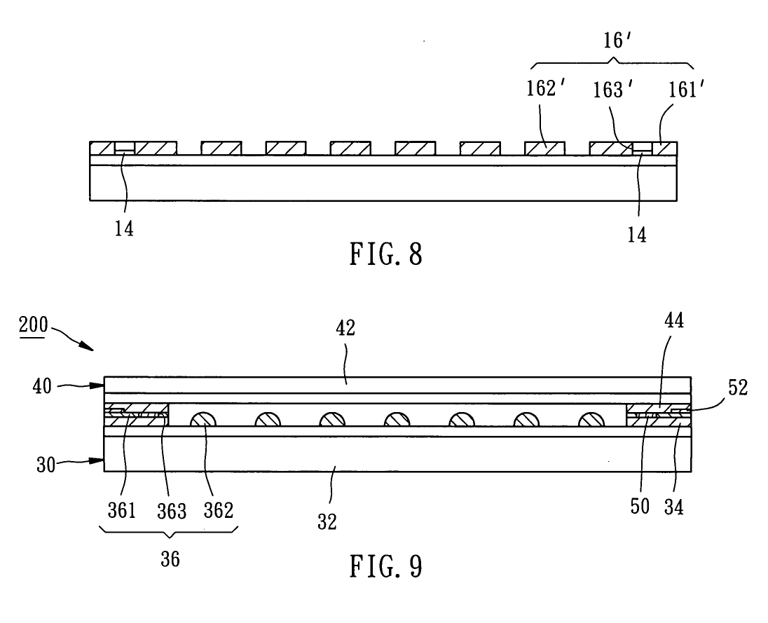

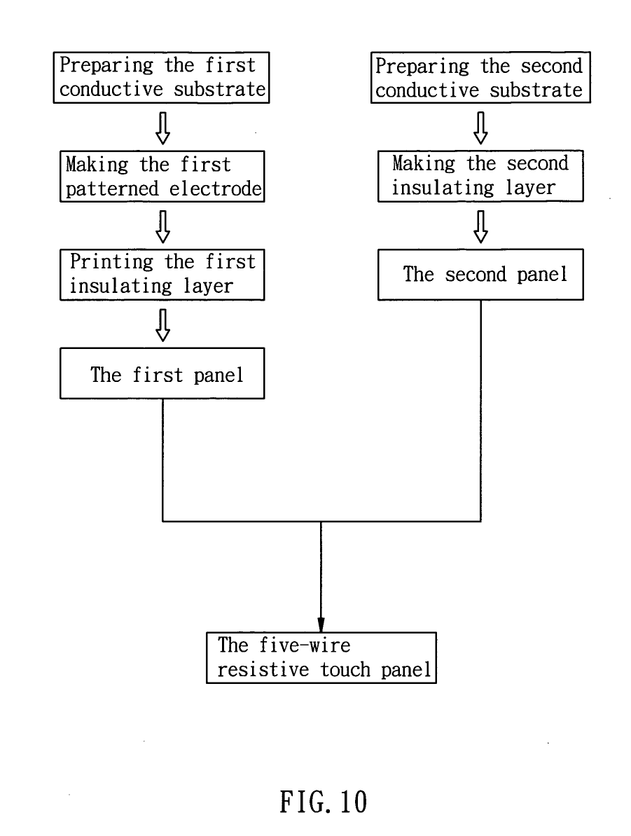

FIG. 9 shows a four wire resistive touch panel, which a method of making it includes the same technical character of the present invention, including a first panel 30 and a second panel 40. The first panel 30 has a first conductive substrate 32, a first patterned electrode 34 and a first insulating layer 36. The second panel 40 has a second conductive substrate 42 and a second patterned electrode 44. The method of making the above touch panel is shown in FIG. 10, which includes the steps of making the first and second panels 30 and 40.

First, forming the first patterned electrode 34 on the first conductive substrate 32, and then performing screen printing process to make the first insulating layer 36 on the first conductive substrate 32. The first insulating layer 36 has a barrier 361, a plurality of spacers 362 and a plurality of through holes 363, wherein the barrier 361 covers the first patterned electrode 34. In the same time, making the second patterned electrode 44 on the second conductive substrate 42, and then coupling the first and second panels 30 and 40 to electrically connect the second patterned electrode 44 to the first patterned electrode 34 through the through holes 363 of the first insulating layer 36. To have a well electrical conduction, conductive pads 50 are provided in the through holes 363, and an adhesive layer 52 is provided between the barrier 361 and the second patterned electrode 44 to keep the first and second panels 30 and 40 with strong coupling.

The description above is a preferred embodiment of the present invention and the equivalence of the present invention is still in the scope of the claim of the present invention.

What is claimed is:

1. A method of fabricating a resistive touch panel, comprising the steps of:
an anterior process for making a first panel, which includes the steps of:
providing a first conductive substrate, on which a first patterned electrode is provided to define a region on the first conductive substrate;
forming a patterned first insulating layer on the first conductive substrate, wherein the first insulating layer has a barrier covering the first patterned electrode, a plurality of spacers received in the region and a plurality of through holes through the barrier;
a posterior process for making a second panel and electrically connecting the second panel to the first panel.

2. The method as defined in claim 1, wherein a process of forming the first insulating layer is screen printing process.

3. The method as defined in claim 2, wherein the screen printing process comprises the steps of:
coating a photosensitive material on the first conductive substrate to form a photoresist layer;
performing exposure and development processes on the photoresist layer to form the first insulating layer with the barrier, the spacer and the through holes.

4. The method as defined in claim 3, wherein the photosensitive material is made of photosensitive acrylic resin.

5. The method as defined in claim 3, wherein the photosensitive material is made of photosensitive polyimide.

6. The method as defined in claim 1, wherein the first patterned electrode is made by screen printing process to print metal wires on the first conductive substrate.

7. The method as defined in claim 1, wherein the anterior process further comprises the steps of:
forming a second patterned electrode on the barrier, wherein the second patterned electrode has a plurality of wires, some of which are electrically connected to the first patterned electrode through the through holes of the first insulating layer.

8. The method as defined in claim 7, wherein the posterior process comprises the steps of:
forming a patterned second insulating layer covering the wires, wherein the second insulating layer has a through hole;
preparing a second conductive substrate and coupling the second conductive substrate with the first conductive substrate, wherein one of the wires of the second patterned electrode is electrically connected to the second conductive substrate through the through hole of the second insulating layer.

9. The method as defined in claim 7, wherein the posterior process comprises the steps of:
preparing a second conductive substrate;
forming a patterned second insulating layer on the second conductive substrate, wherein the second insulating layer has a through hole;
coupling the first conductive substrate with the second conductive substrate, wherein one of the wires of the second patterned electrode is electrically connected to the second conductive substrate through the through hole of the second insulating layer.

10. The method as defined in claim 1, wherein the posterior process comprises the steps of:
preparing a second conductive substrate;
forming a patterned second insulating layer on the second conductive substrate, wherein the second insulating layer has a through hole;
forming a second patterned electrode on the second insulating layer, wherein the second patterned electrode has a plurality of wires, one of which is electrically connected to the second conductive substrate through the through hole of the second insulating layer;
coupling the first conductive substrate with the second conductive substrate, wherein the rest wires of the second patterned electrode are electrically connected to the first patterned electrode through the through holes of the first insulating layer.

11. The method as defined in claim 1, wherein the posterior process comprises the steps of:
preparing a second conductive substrate;
forming a patterned second insulating layer on the second conductive substrate;
coupling the first conductive substrate with the second conductive substrate, wherein the second patterned electrode is electrically connected to the first patterned electrode through the through holes of the first insulating layer.
